(19) United States
(12) Patent Application Publication
(10) Pub. No.: US 2017/0138535 A1
(43) Pub. Date: May 18, 2017

(54) SAFETY GUARD

(71) Applicant: Joseph Edward Jill, Cypress, CA (US)

(72) Inventor: Joseph Edward Jill, Cypress, CA (US)

(21) Appl. No.: 15/351,210

(22) Filed: Nov. 14, 2016

Related U.S. Application Data
(60) Provisional application No. 62/285,924, filed on Nov. 13, 2015.

(51) Int. Cl. F16P 1/02

(52) U.S. Cl. CPC F16P 1/02

(57) ABSTRACT

A safety guard for protecting individuals from flying debris while a vehicle is being serviced or parked on a dynamometer. The safety guard includes a fame a screen, a first horizontal support member and a second horizontal support member secured to a surface. The frame includes a first side member extending vertically relative the surface; a second side member extending vertically relative to the surface; and a top member extending horizontally relative to the surface and connected to the first side member and the second side member. The safety guard may be secured to the surface by a pair of receptacle integrally, or detachably, connected to the surface where the frame is inserted into the receptacles. Alternatively, the frame of the safety guard may be inserted and secured into opening located within the surface.

### CROSS REFERENCE TO RELATED APPLICATIONS

This application claims priority to a provisional application, U.S. Ser. No. 62/285,924, filed Nov. 13, 2015, entitled Chassis Dyno Wheel Guard, which is hereby incorporated by reference. Nov. 13, 2016 fell on a Sunday so this application is being filed the next business day which is Nov. 14, 2016.

### FIELD OF THE INVENTION

The present disclosure relates to a safety guard for protecting individuals from flying debris while a vehicle is being serviced. More particularly, the safety guard of the present invention is utilized to protect individual's debris coming from a vehicle while it is on a dynamometer (or “dyno”).

### BACKGROUND OF INVENTION

Servicing of vehicles, especially the servicing of tires on a vehicle can be extremely hazardous resulting in injury or death to nearby individuals. When working with tires on a vehicle, especially a large vehicle having inflated large tires, a large amount of stored energy is located within the inflated large vehicle tire. Improper handling and assembly of the tire or rim/wheel can cause the components to explode for project outwardly from the vehicle which can result in costly damage to surrounding equipment, but most dangerously can result in serious injury or death to individuals.

Additionally, to determine characteristics of the motor of a vehicle, including but not limited to horsepower and torque, the vehicle is parked on a dynamometer. A dynamometer, also known as a rolling road, comprises at least one drive roller which is substantially located below the ground with a portion of the drive roller extending above the ground. The tires of a vehicle are parked on the driver roller of the dynamometer. FIG. 7 illustrates the rear tires of a vehicle on the drive roller of a dynamometer. The dynamometer measures power delivered to the surface of the drive roller by the drive wheels of the vehicle. The vehicle is often parked on the roller or rollers, which the car then turns, and the output measured thereby. While these measurements are being gathered and the dynamometer is running, parts from the vehicle have been known to fly outwards striking individuals resulting in serious injury or death.

In view of the above, what is needed is a safety guard to protect individuals and surrounding areas from outwardly projecting or exploding parts (or debris) while a vehicle is being serviced as well as when a vehicle is parked on a running dynamometer.

### SUMMARY OF INVENTION

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

A safety guard, mounted to a surface, for protecting an individual from injury or death from debris projected from a vehicle being while parked on a dynamometer is provided. The safety guard includes a frame, the frame comprising a first side member extending vertically relative the surface; a second side member extending vertically relative to the surface; and a top member extending horizontally relative to the surface and connected to the first side member and the second side member. The safety guard further comprises a first horizontal support member extending between the first and second side members of the frame; a second horizontal support member extending between the first and second side members of the frame; a protective screen secured to the first and second horizontal support members; a first sleeve for mounting to the ground surface and adapted to receive the first side member; and a sleeve receptacle for mounting to the ground surface and adapted to receive the second side member.

According to one aspect, the safety guard further comprises an arcuate shape of the top member connecting to the first side member and the second side member.

According to another aspect, the protective screen is made of ¼″ expanded metal.

According to yet another aspect, wherein each of the first and second sleeves comprises a flat elongated bottom member; a frame receptacle secured to the flat elongated bottom member and extending vertically upward, the frame receptacle being hollow and having a pin opening located in one of the side of the receptacle; and wherein an end of the first side member or the second side member is inserted into the frame receptacle.

According to yet another aspect, each of the first side member and the second member include a pin frame opening extending through the side member; and wherein when the first side member or the second side member is inserted into the frame receptacle a pin is configured for insertion into the pin opening and the pin frame opening; and wherein the pin opening and the pin frame opening are located within the same horizontal plane allowing the pin to be inserted through the pin opening and the pin frame opening while remaining parallel with the surface.

According to yet another aspect, the first side member includes a first upper elongated receptacle member and a first lower elongated receptacle member secured to the first side member of the frame, and wherein the first upper elongated receptacle member and the first elongated receptacle member are located within the same vertical plane.

According to yet another aspect, the second side member includes a second upper elongated receptacle member and a second lower elongated receptacle member secured to the second side member of the frame, and wherein the second upper elongated receptacle member and the second elongated receptacle member are located within the same vertical plane.

According to yet another aspect, the first and second upper elongated receptacle members are located within the same first horizontal plane and the first and second elongated receptacle members are located within the same second horizontal plane, where the first horizontal plane is different than the second horizontal plane.

According to yet another aspect, the safety guard further comprises a first side panel, the first side panel comprising: a first bottom edge, a first outer edge, a first inner edge and a first top arcuate edge integrally formed together; a first upper notch in the first inner edge having a first upper elongated rod fixedly attached to and extending downwardly from to an upper edge of the first upper notch; and a first lower notice in the first inner edge, located below and in the same horizontal plane as the first upper notch, having a first lower elongated rod fixedly attached to and extending downwardly from an upper edge of the first lower notch; wherein the first upper elongated rod is adapted to be received in the first upper elongated receptacle member of the first side member of the frame; and wherein the first lower elongated rod is adapted to be received in the first lower elongated receptacle member of the first side member of the frame.

According to yet another aspect, the first upper elongated pin and the first lower elongated pin can rotate within the first upper elongated receptacle member and the first lower elongated receptacle member allowing the first panel to rotate about the first side member of the frame.

According to yet another aspect, the first side panel includes a first elongated opening located in a top portion of the first panel.

According to yet another aspect, the first side panel is detachably secured to the frame.

According to yet another aspect, the safety guard further comprises a second side panel, the second side panel comprising: a second bottom edge, a second outer edge, a second inner edge and a second top arcuate edge integrally formed together; a second upper notch in the second inner edge having a second upper elongated rod fixedly attached to and extending downwardly from to an upper edge of the second upper notch; and a second lower notice in the second inner edge, located below and in the same horizontal plane as the second upper notch, having a second lower elongated rod fixedly attached to and extending downwardly from an upper edge of the second lower notch; wherein the second upper elongated rod is adapted to be received in the second upper elongated receptacle member of the second side member of the frame; and wherein the second lower elongated rod is adapted to be received in the second lower elongated receptacle member of the second side member of the frame.

According to yet another aspect, the second upper elongated pin and the second lower elongated pin can rotate within the second upper elongated receptacle member and the second lower elongated receptacle member allowing the second panel to rotate about the second side member of the frame.

According to yet another aspect, the second side panel includes a second elongated opening located in a top portion of the second panel.

According to yet another aspect, the second side panel is detachably secured to the frame.

According to yet another aspect, the vertical distance between the first side member and the second side member is 3.5 inches.

According to yet another aspect, the first horizontal support member and the second horizontal support member are located on opposite sides of the protective screen.

According to yet another aspect, the vertical distance between the top member of the frame and the first horizontal member is the same vertical distance between the first horizontal member and the second horizontal member.

### BRIEF DESCRIPTION OF DRAWINGS

FIG. 1 illustrates a front elevation view of the safety guard according to an embodiment of the invention.

FIG. 2 illustrates a front elevation view of the safety guard of FIG. 1 having side panels.

FIG. 3 illustrates a back elevation view of the safety guard of FIG. 1 having side panels.

FIG. 4 illustrates a front elevation view of the safety guard according to another embodiment of the invention.

FIG. 5 illustrates a front elevation view of the safety guard of FIG. 4 having side panels.

FIG. 6 illustrates a back elevation view of the safety guard of FIG. 4 having side panels.

FIG. 7 illustrates rear tires of a vehicle on top of a dynamometer

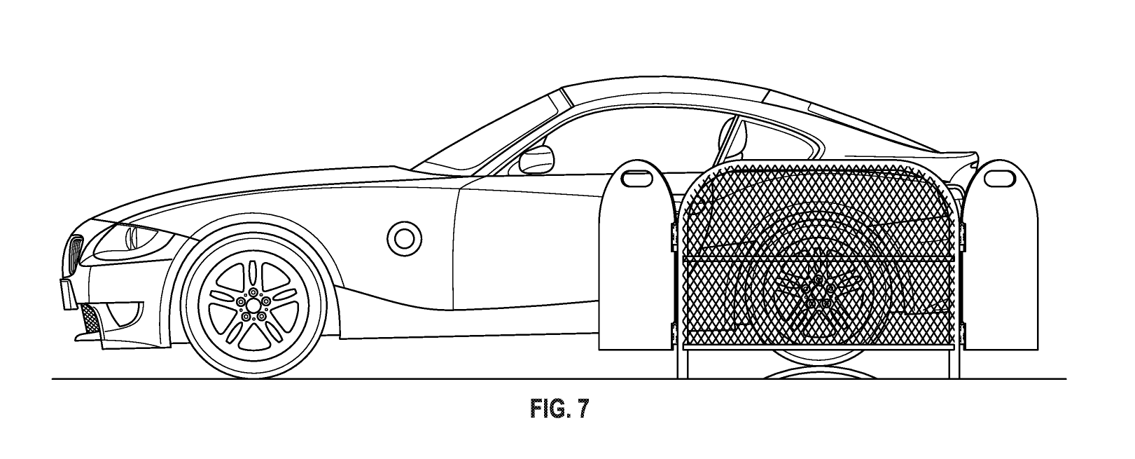

### DETAILED DESCRIPTION

The following detailed description is of the best currently contemplated modes of carrying out the invention. The description is not to be taken in a limiting sense, but is made merely for the purpose of illustrating the general principles of the invention.

### Overview

Embodiments of a safety guard for protecting individuals from flying debris while a vehicle is being service or parked on a dynamometer are provided. In one embodiment, the safety guard includes a frame, a screen, a first horizontal support member and a second horizontal support member secured to a ground surface. The safety guard may be secured to the ground surface by a pair of receptacles integrally, or detachably, connected to the ground surface where the frame is inserted into the receptacles. Alternatively, the frame of the safety guard may be inserted and secured into openings or holes located within the ground surface.

### Safety Guard

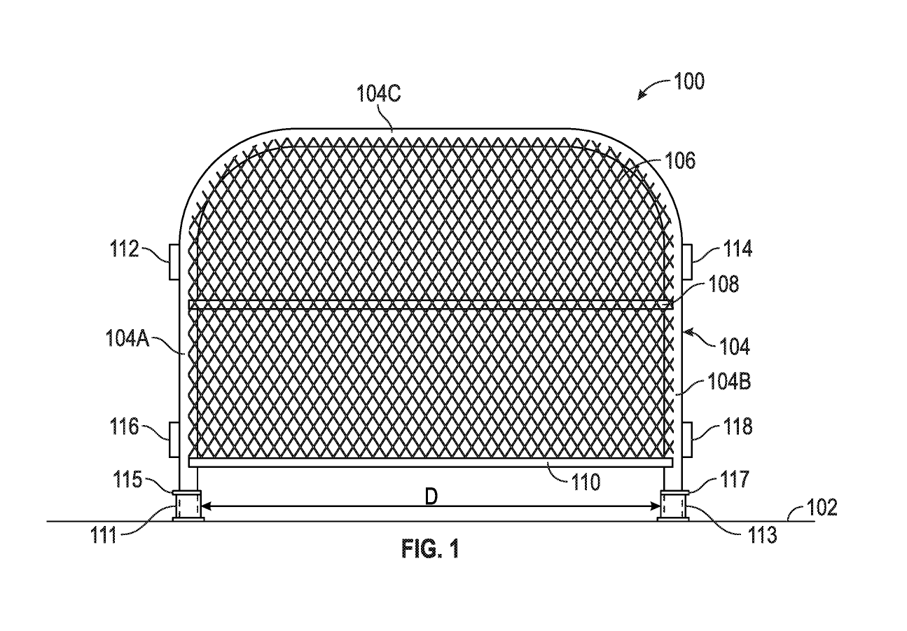

FIG. 1 illustrates a side elevation view of the safety guard according to an embodiment of the invention. The safety guard may be secured to the top of a ground surface 102 by receptacles, as described in further detail below.

The safety guard 100 may include a frame 104, a screen 106, a first horizontal support member 108 and a second horizontal support member 110. In one embodiment, the frame 104 may include a first side member 104a extending vertically relative the ground surface 102, a second side member 104b extending vertically relative to the ground surface 102 and a top member 104c extending horizontally relative to the ground surface 102 and integrally connected to the first side member 104a and the second side member 104b. As shown, the connection between the first side member 104a and the top member 104c may have an arcuate configuration and the connection between the second side member 104b and the top member 104c may have an arcuate configuration. According to one embodiment, the screen 106 may be detachably secured to the frame 104 and may be made of ¼″ expanded metal, a mesh screen, or any other material known in the art. The frame 104 may be comprised of a single member having a generally u-shaped configuration. Alternatively, the frame 104 may be comprises of multiple members integrally or detachably connected.

The safety guard 100 may further include a first sleeve 111 and a second sleeve 113 which may be fixedly or detachably secured to the ground surface. The first sleeve 111 may be adapted to receive an end of the first side member 104a and the second sleeve 113 may be adapted to receive an end of the second side member 104b. A first hole may be located on an outer side of the first sleeve 111 and a second hole may be located on outer side of the second sleeve 113. The first and second holes correspond with holes extending through the first and second side members 104a, 104b, respectively. Once the first and second side members 104a, 104b are inserted within the first and second sleeves 111, 113, a first pin 115 may be inserted through the first hole in the first sleeve 111 and pushed through the corresponding holes in the first side member 104a securing the first side member 104a to the first sleeve 111. Next, a second pin 117 may be inserted through the second hole in the second sleeve 113 and pushed through the corresponding holes in the second side member 104b securing the second side member 104b to the second sleeve 113.

According to one embodiment, each of the first and second sleeves 111, 113 comprise a flat elongated bottom member, a frame receptacle secured to the flat elongated bottom member and extending vertically upward, the frame receptacle being hollow and having a pin opening located in one of the side of the receptacle and wherein an end of the first side member or the second side member is inserted into the frame receptacle.

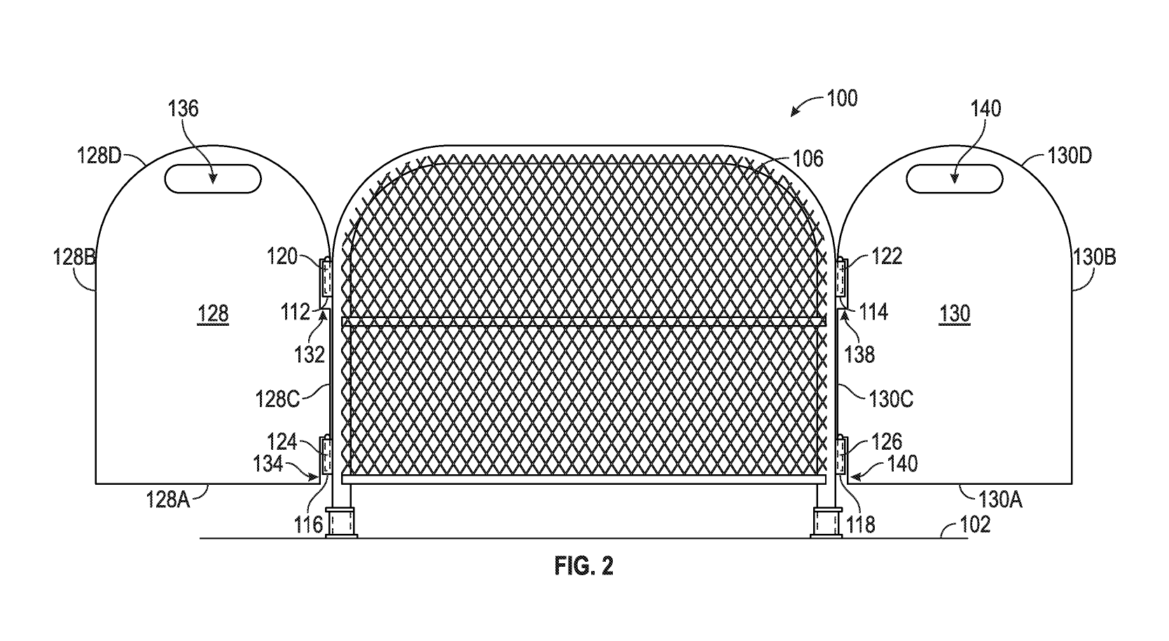

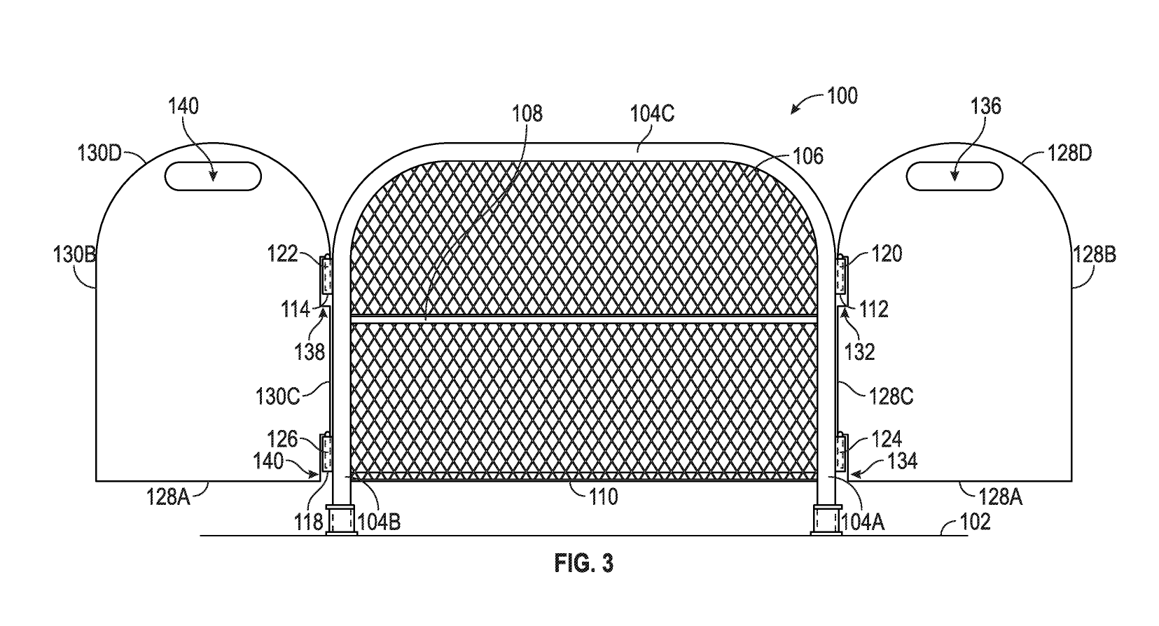

According to one embodiment, each of the first and second side members 104a, 104b may include an upper elongated receptacle member 112, 114, respectively, and a lower elongated receptacle member 116, 118, respectively, adapted to receive elongated rods 120, 122, 124, and 126 for securing a first panel 128 and a second panel 130 to the frame 104. FIGS. 2 and 3 illustrate front and back elevation views, respectively, of the safety guard with the first and second side panels 128, 130 secured to the frame 104 of the safety guard 100. As shown, when securing the first panel 128 to the first side member 104a of the frame 104, a first upper elongated rod 120 is inserted into a first upper elongated receptacle member 112 and a first lower elongated rod 124 is inserted into the first lower elongated receptacle member 116. In one embodiment, the elongated rods 120, 124 may rotate within the elongated receptacle members 112, 116 allowing the first side panel 128 to rotate and adjust to a proper position.

The elongated rods 120-126 extend downwards ¾ into the elongated receptacle members 112-118. That is, the elongated rods 120-126 do not extend the entire vertical length of the elongated receptacle members 112-118.

Furthermore, when securing the second panel 130 to the second side member 104b of the frame 104, a second upper elongated rod 122 is inserted into a second upper elongated receptacle member 114 and a second lower elongated rod 126 is inserted into the second lower elongated receptacle member 118. In one embodiment, the elongated rods 122, 126 may rotate within the elongated receptacle members 112, 116 allowing the second side panel 130 to rotate and adjust to a proper position.

According to one embodiment, the first and second side panels 128, 130 may rotate inward into a folding position when not in use.

According to one embodiment, the first and second side panels 128, 130 may rotate from a first position, where the first position is when the first and second side panels 128, 130 are located in a first vertical plane which is the same vertical plane in which the frame 104 is located, to a second position where the first and second side panels are located in a second vertical plane which is different than the vertical plane in which the frame 104 is located. The first and second side panels may be rotated, 45 degrees from the first vertical plane, 90 degrees from the first vertical plane, 180 degrees from the first vertical plane or any degree between 0 and 180.

According to one embodiment, the first and second side panels 128 and 130 may be rotated inwardly or outwardly such that the first and second side panels 128, 130 are capable of rotating 360 degrees.

According to one embodiment, the side panels 128 and 130 rotate independently such that the side panels 128, 130 are located in different vertical planes.

The first and second side panels 128, 130 may be formed from any material known in the art that is strong enough to stop flying debris, including but not limited to, metal and carbon steel. As shown, the first side panel 128 may have a generally rectangular shape with a curved or arcuate top. The first side panel 128 includes a first bottom edge 128a edge, a first outer edge 128b, a first inner edge 128c and a first top edge 128d. The first bottom edge 128a extends horizontally relative to the ground surface 102 and the first outer edge 128b extending vertically relative to the ground surface 102. A first upper notch 132 and a first lower notch 134 having generally rectangular configurations are formed into opposite ends of the first inner edge 128c. The first upper elongated rod 120 is fixedly attached and extends perpendicularly downward from an upper edge of the first upper notch 132. The first lower elongated rod 124 is fixedly attached and extends perpendicularly downward from an upper edge of the first lower notch 134. The first upper and first lower notches 132, 134 allow for the first side panel 128 to be adjusted with respect to the frame 104. Although the first top edge 128d is shown having an arcuate configuration, this is by way of example only and the first top edge 128d may have any configuration. In one example, the first side panel 128 may include an opening 136 which may be utilized by a user to move or adjust the first side panel 128 with respect to the frame. Although the opening 136 is shown having an oval configuration, this is by way of example only and the opening 136 may have any configuration. Alternatively, the first side panel 128 may be solid and not include and openings.

Furthermore, the second side panel 130 may have a generally rectangular shape with a curved or arcuate top. The second side panel 130 includes a second bottom edge 130a edge, a second outer edge 130b, a second inner edge 130c and a second top edge 130d. The second bottom edge 130a extends horizontally relative to the ground surface 102 and the second outer edge 130b extending vertically relative to the ground surface 102. A second upper notch 138 and a second lower notch 140 having generally rectangular configurations are formed into opposite ends of the second inner edge 130c. The second upper elongated rod 122 is fixedly attached and extends perpendicularly downward from an upper edge of the second upper notch 138. The second lower elongated rod 126 is fixedly attached and extends perpendicularly downward from an upper edge of the second lower notch 140. The second upper and second lower notches 138, 140 allow for the second side panel 130 to be adjusted in a horizontal plane with respect to the frame 104. Although the second top edge 130d is shown having an arcuate configuration, this is by way of example only and the second top edge 130d may have any configuration. In one example, the second side panel 130 may include an opening 140 which may be utilized by a user to move or adjust the second side panel 130 with respect to the frame 104. Although the opening 140 is shown having an oval configuration, this is by way of example only and the opening 140 may have any configuration. Alternatively, the second side panel 130 may be solid and not include and openings.

According to one embodiment, the horizontal distance between the first sleeve 111 and a second sleeve 113 is 3.5 feet.

According to one embodiment, the first horizontal support member 108 and the second horizontal support member 110 are located on opposite sides of the screen 106.

According to one embodiment, the first horizontal support member 108 and the second horizontal support member 110 are located on the same side of the screen 106.

According to one embodiment, the distance vertical distance between the top member 104c of the frame and the first horizontal member 108 is the same vertical distance between the first horizontal member 108 and the second horizontal member 110.

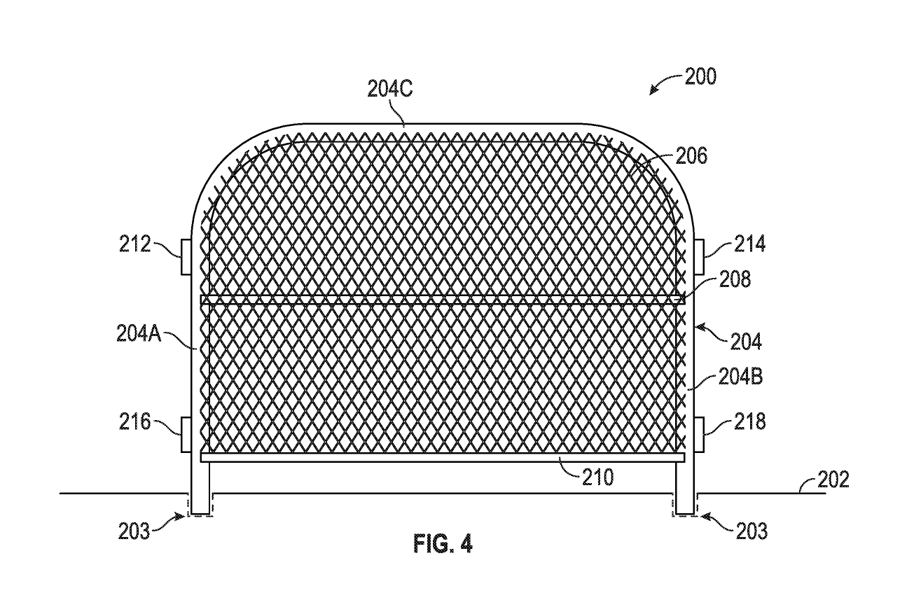

FIG. 4 illustrates a front elevation view of the safety guard according to another embodiment of the invention. The safety guard 200 may be secured within openings 203 located within the ground surface 202 designed to specifically receive the safety guard 200. First and second side members of the frame of the safety guard, described below, may be inserted into the opening in the ground surface 202 and secured by any method known in the art. For example, the first and second side members may be fixedly secured within the openings 203 using cement.

The safety guard 200 may include a frame 204, a protective screen 206, a first horizontal support member 208 and a second horizontal support member 210. In one embodiment, the frame 204 may include a first side member 204a extending vertically relative the ground surface 202, a second side member 204b extending vertically relative to the ground surface 202 and a top member 204c extending horizontally relative to the ground surface 202 and integrally connected to the first side member 204a and the second side member 204b. As shown, the connection between the first side member 204a and the top member 204c may have an arcuate configuration and the connection between the second side member 204b and the top member 204c may have an arcuate configuration. According to one embodiment, the screen 206 may be detachably secured to the frame 204 and may be made of ¼″ expanded metal, a mesh screen, or any other material known in the art.

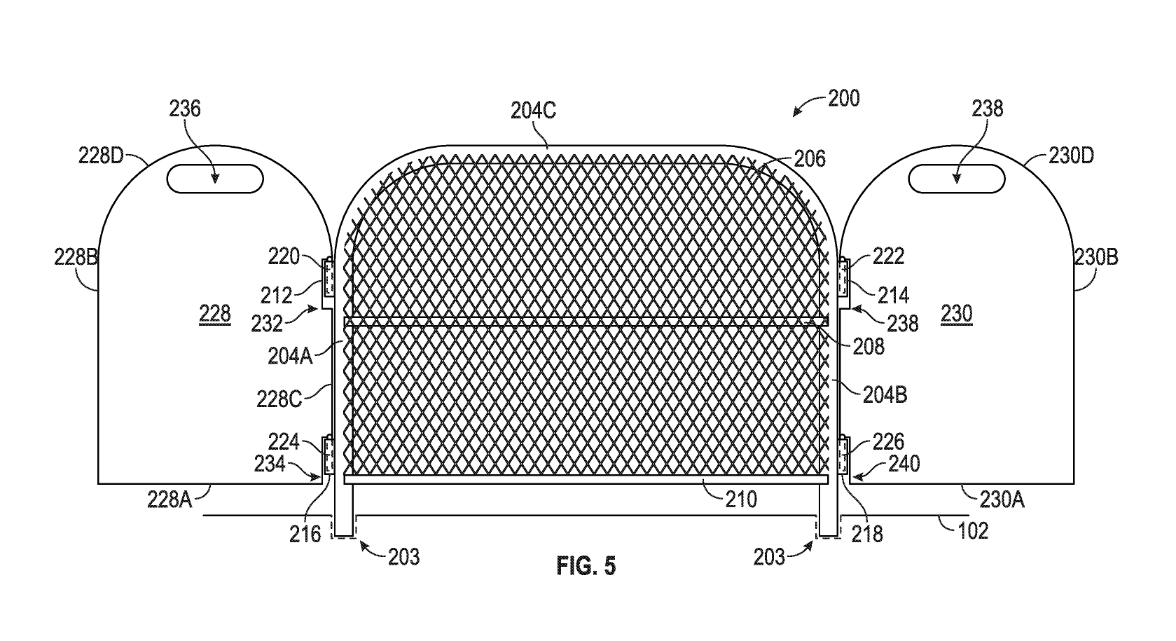

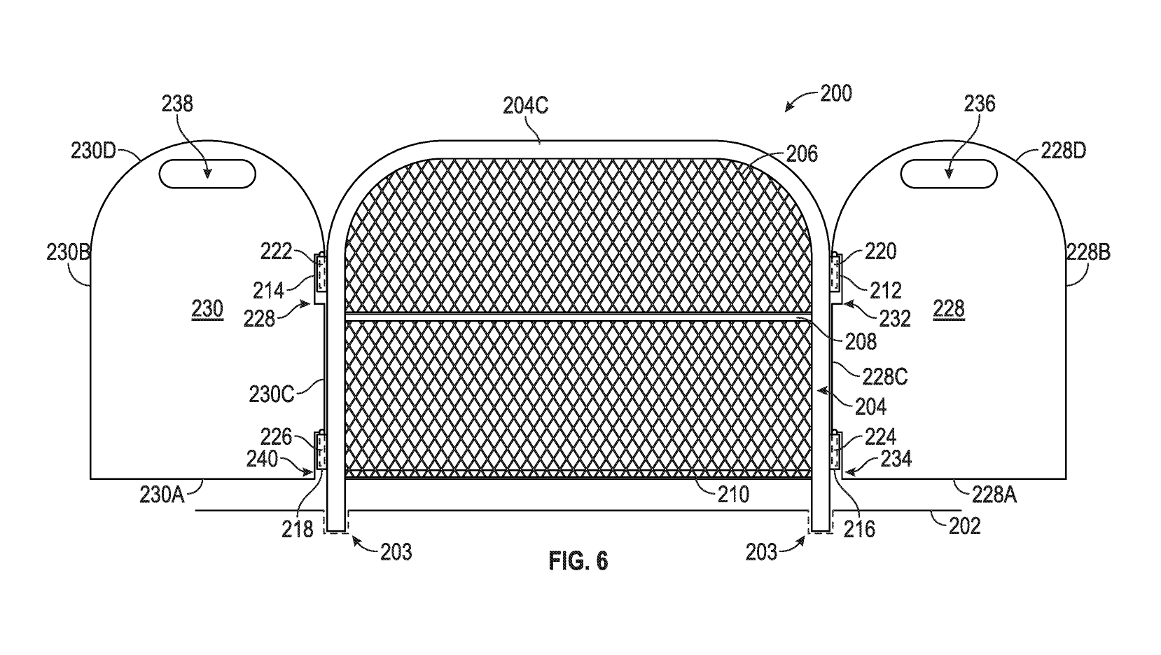

According to one embodiment, each of the first and second side members 204a, 204b may include an upper elongated receptacle member 212, 214, respectively, and a lower elongated receptacle member 216, 218, respectively, adapted to receive elongated rods 220, 222, 224, and 226 for securing a first panel 228 and a second panel 230 to the frame 204. FIGS. 5 and 6 illustrate front and back elevation views, respectively, of the safety guard with the first and second side panels 228, 230 secured to the frame 204 of the safety guard 200. As shown, when securing the first panel 228 to the first side member 204a of the frame 204, a first upper elongated rod 220 is inserted into a first upper elongated receptacle member 212 and a first lower elongated rod 224 is inserted into the first lower elongated receptacle member 216. In one embodiment, the elongated rods 220, 224 may rotate within the elongated receptacle members 212, 216 allowing the first side panel 228 to rotate.

Furthermore, when securing the second panel 230 to the second side member 204b of the frame 204, a second upper elongated rod 222 is inserted into a second upper elongated receptacle member 114 and a second lower elongated rod 226 is inserted into the second lower elongated receptacle member 218. In one embodiment, the elongated rods 222, 226 may rotate within the elongated receptacle members 212, 216 allowing the second side panel 230 to rotate.

According to one embodiment, the first and second side panels 228, 230 may rotate inward into a folding position when not in use.

According to one embodiment, the first and second side panels 228, 230 may rotate from a first position, where the first position is when the first and second side panels 228, 230 are located in a first vertical plane which is the same vertical plane in which the frame 204 is located, to a second position where the first and second side panels are located in a second vertical plane which is different than the vertical plane in which the frame 204 is located. The first and second side panels may be rotated, 45 degrees from the first vertical plane, 90 degrees from the first vertical plane, 180 degrees from the first vertical plane or any degree between 0 and 180.

According to one embodiment, the first and second side panels 228 and 230 may be rotated inwardly or outwardly such that the first and second side panels 228, 230 are capable of rotating 360 degrees.

According to one embodiment, the side panels 228 and 230 rotate independently such that the side panels 228, 230 are located in different vertical planes.

The first and second side panels 228, 230 may be formed from any material known in the art that is strong enough to stop flying debris, including but not limited to, metal and carbon steel. As shown, the first side panel 228 may have a generally rectangular shape with a curved or arcuate top. The first side panel 228 includes a first bottom edge 228a edge, a first outer edge 228b, a first inner edge 228c and a first top edge 228d. The first bottom edge 228a extends horizontally relative to the ground surface 202 and the first outer edge 228b extending vertically relative to the ground surface 202. A first upper notch 232 and a first lower notch 234 having generally rectangular configurations are formed into opposite ends of the first inner edge 228c. The first upper elongated rod 220 is fixedly attached and extends perpendicularly downward from an upper edge of the first upper notch 232. The first lower elongated rod 224 is fixedly attached and extends perpendicularly downward from an upper edge of the first lower notch 234. The first upper and first lower notches 232, 234 allow for the first side panel 228 to be adjusted in a horizontal plane with respect to the frame 204. Although the first top edge 228d is shown having an arcuate configuration, this is by way of example only and the first top edge 228d may have any configuration. In one example, the first side panel 228 may include an opening 236 which may be utilized by a user to move or adjust the first side panel 128 with respect to the frame. Although the opening 236 is shown having an oval configuration, this is by way of example only and the opening 236 may have any configuration.

Furthermore, the second side panel 230 may have a generally rectangular shape with a curved or arcuate top. The second side panel 230 includes a second bottom edge 230a edge, a second outer edge 230b, a second inner edge 230c and a second top edge 230d. The second bottom edge 230a extends horizontally relative to the surface 202 and the second outer edge 230b extending vertically relative to the surface 202. A second upper notch 238 and a second lower notch 240 having generally rectangular configurations are formed into opposite ends of the second inner edge 230c. The second upper elongated rod 222 is fixedly attached and extends perpendicularly downward from an upper edge of the second upper notch 238. The second lower elongated rod 226 is fixedly attached and extends perpendicularly downward from an upper edge of the second lower notch 240. The second upper and second lower notches 238, 240 allow for the second side panel 230 to be adjusted in a horizontal plane with respect to the frame 204. Although the second top edge 230d is shown having an arcuate configuration, this is by way of example only and the second top edge 230d may have any configuration. In one example, the second side panel 230 may include an opening 240 which may be utilized by a user to move or adjust the second side panel 230 with respect to the frame 204. Although the opening 240 is shown having an oval configuration, this is by way of example only and the opening 240 may have any configuration.

The elongated rods 220-226 extend downwards ¾ into the elongated receptacle members 212-218. That is, the elongated rods 220-226 do not extend the entire vertical length of the elongated receptacle members 212-218.

According to one embodiment, the horizontal distance (D) between the first side member 204a and the second side member 204b is 3.5 feet.

According to one embodiment, the first horizontal support member 208 and the second horizontal support member 210 are located on opposite sides of the screen 206.

According to one embodiment, the first horizontal support member 208 and the second horizontal support member 210 are located on the same side of the screen 206.

According to one embodiment, the distance vertical distance between the top member 204c of the frame and the first horizontal member 208 is the same vertical distance between the first horizontal member 208 and the second horizontal member 210.

Advantageously, the safety guard according to embodiments of the invention can be used to protect individuals from parts or debris projecting or flying out from a vehicle while it is being serviced or while parked on a dynamometer. As a result, using the safety guard saves individuals from injury or death that can occur from flying debris or parts.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A safety guard, mounted to a ground surface, for protecting an individual from injury or death from debris projected from a vehicle while parked on a dynamometer, comprising:
a frame, the frame comprising:
a first side member extending vertically relative the surface;
a second side member extending vertically relative to the surface; and
a top member extending horizontally relative to the surface and connected to the first side member and the second side member;
a first horizontal support member extending between the first and second side members of the frame;
a second horizontal support member extending between the first and second side members of the frame;
a protective screen secured to the first and second horizontal support members;
a first sleeve for mounting to the ground surface and adapted to receive the first side member; and
a sleeve receptacle for mounting to the ground surface and adapted to receive the second side member.

2. The safety guard of claim 1, further comprising an arcuate shape of the top member connecting to the first side member and the second side member.

3. The safety guard of claim 1, wherein the protective screen is made of ¼″ expanded metal.

4. The safety guard of claim 1, wherein each of the first and second sleeves comprises:
a flat elongated bottom member;
a frame receptacle secured to the flat elongated bottom member and extending vertically upward, the frame receptacle being hollow and having a pin opening located in one of the side of the receptacle; and
wherein an end of the first side member or the second side member is inserted into the frame receptacle.

5. The safety guard of claim 4, wherein each of the first side member and the second member include a pin frame opening extending through the side member; and wherein when the first side member or the second side member is inserted into the frame receptacle a pin is configured for insertion into the pin opening and the pin frame opening; and wherein the pin opening and the pin frame opening are located within the same horizontal plane allowing the pin to be inserted through the pin opening and the pin frame opening while remaining parallel with the surface.

6. The safety guard of claim 1, where the first side member includes a first upper elongated receptacle member and a first lower elongated receptacle member secured to the first side member of the frame, wherein the first upper elongated receptacle member and the first elongated receptacle member are located within the same vertical plane.

7. The safety guard of claim 6, where the second side member includes a second upper elongated receptacle member and a second lower elongated receptacle member secured to the second side member of the frame, wherein the second upper elongated receptacle member and the second elongated receptacle member are located within the same vertical plane.

8. The safety guard of claim 7, wherein the first and second upper elongated receptacle members are located within the same first horizontal plane and the first and second elongated receptacle members are located within the same second horizontal plane, where the first horizontal plane is different than the second horizontal plane.

9. The safety guard of claim 8, further comprising a first side panel, the first side panel comprising:
a first bottom edge, a first outer edge, a first inner edge and a first top arcuate edge integrally formed together;
a first upper notch in the first inner edge having a first upper elongated rod fixedly attached to and extending downwardly from to an upper edge of the first upper notch; and
a first lower notice in the first inner edge, located below and in the same horizontal plane as the first upper notch, having a first lower elongated rod fixedly attached to and extending downwardly from an upper edge of the first lower notch;
wherein the first upper elongated rod is adapted to be received in the first upper elongated receptacle member of the first side member of the frame; and
wherein the first lower elongated rod is adapted to be received in the first lower elongated receptacle member of the first side member of the frame.

10. The safety guard of claim 9, wherein the first upper elongated pin and the first lower elongated pin can rotate within the first upper elongated receptacle member and the first lower elongated receptacle member allowing the first panel to rotate about the first side member of the frame.

11. The safety guard of claim 10, wherein the first side panel includes a first elongated opening located in a top portion of the first panel.

12. The safety guard of claim 10, wherein the first side panel is detachably secured to the frame.

13. The safety guard of claim 8, further comprising a second side panel, the second side panel comprising:
a second bottom edge, a second outer edge, a second inner edge and a second top arcuate edge integrally formed together;
a second upper notch in the second inner edge having a second upper elongated rod fixedly attached to and extending downwardly from to an upper edge of the second upper notch; and
a second lower notice in the second inner edge, located below and in the same horizontal plane as the second upper notch, having a second lower elongated rod fixedly attached to and extending downwardly from an upper edge of the second lower notch;
wherein the second upper elongated rod is adapted to be received in the second upper elongated receptacle member of the second side member of the frame; and
wherein the second lower elongated rod is adapted to be received in the second lower elongated receptacle member of the second side member of the frame.

14. The safety guard of claim 13, wherein the second upper elongated pin and the second lower elongated pin can rotate within the second upper elongated receptacle member and the second lower elongated receptacle member allowing the second panel to rotate about the second side member of the frame.

15. The safety guard of claim 14, wherein the second side panel includes a second elongated opening located in a top portion of the second panel.

16. The safety guard of claim 15, wherein the second side panel is detachably secured to the frame.

17. The safety guarded of claim 1, wherein the vertical distance between the first side member and the second side member is 3.5 inches.

18. The safety guard of claim 1, wherein the first horizontal support member and the second horizontal support member are located on opposite sides of the protective screen.

19. The safety guard of claim 1, wherein the vertical distance between the top member of the frame and the first horizontal member is the same vertical distance between the first horizontal member and the second horizontal member.
